(19) United States
(12) Patent Application Publication
(10) Pub. No.: US 2024/0221102 A1
(43) Pub. Date: Jul. 4, 2024

(54) DATA MANAGEMENT SYSTEM, DATA MANAGEMENT METHOD, AND SERVER

(71) Applicant: TOYOTA JIDOSHA KABUSHIKI KAISHA, Toyota-shi (JP)

(72) Inventors: Kazuya NISHIMURA, Anjo-shi (JP); Josuke YAMANE, Nagoya-shi (JP); Soutaro KANEKO, Nagoya-shi (JP)

(73) Assignee: TOYOTA JIDOSHA KABUSHIKI KAISHA, Toyota-shi (JP)

(21) Appl. No.: 18/393,899

(22) Filed: Dec. 22, 2023

(30) Foreign Application Priority Data
Dec. 28, 2022 (JP) 2022-212124

(51) Int. Cl. G06Q 50/26; G06Q 30/018; G07C 5/02; G07C 5/08; H04L 67/12

(52) U.S. Cl. CPC G06Q 50/265; G06Q 30/018; G07C 5/02; G07C 5/0841; H04L 67/12

(57) ABSTRACT

A data management system includes a marketplace that manages a digital asset as a non-fungible token (NFT), and a driver terminal used by a driver of a vehicle to acquire the NFT. The marketplace registers a plurality of target conditions in association with the NFT, the plurality of target conditions being conditions concerning at least one of environment and safety that are desired to be achieved during driving. The marketplace obtains data for determining whether driving of the vehicle by the driver has achieved a selected target condition, from the vehicle, the driver terminal, or a data center. When the driving of the vehicle by the driver has achieved the selected target condition, the marketplace gives the NFT associated with the achieved target condition to the driver terminal.

### CROSS REFERENCE TO RELATED APPLICATIONS

This nonprovisional application is based on Japanese Patent Application No. 2022-212124 filed on Dec. 28, 2022 with the Japan Patent Office, the entire contents of which are hereby incorporated by reference.

### BACKGROUND

### Field

The present disclosure relates to a data management system, a data management method, and a server.

### Description of the Background Art

Japanese Patent Laying-Open No. 2022-13271 discloses a distribution platform for non-fungible tokens that does not require preparation of a wallet, management of a secret key, and payment of a network fee (such as gas).

### SUMMARY

Vehicles are widely utilized as transportation means. In recent years, all drivers are required to perform driving in consideration of environment. Further, safe driving is a natural duty for all drivers. Nevertheless, there may be cases where driving in full consideration of environment is not performed or sufficient safe driving is not performed. The present disclosure has been made to solve the aforementioned problem, and one of the objects of the present disclosure is to promote driving in consideration of at least one of environment and safety.
(1) A data management system in accordance with a first aspect of the present disclosure includes a server that manages a digital asset as a non-fungible token (NFT), and a first computer apparatus used by a driver of a vehicle to acquire the NFT. The server registers each of a plurality of target conditions in association with the NFT, the plurality of target conditions being conditions concerning at least one of environment and safety that are desired to be achieved during driving. The first computer apparatus notifies the server of a target condition selected by the driver from the plurality of target conditions. The server obtains, from the vehicle, the first computer apparatus, or an external server, data for determining whether driving of the vehicle by the driver has achieved the selected target condition, and when the driving of the vehicle by the driver has achieved the selected target condition, the server gives the NFT associated with the achieved target condition to the first computer apparatus.
(2) The data management system further includes a second computer apparatus that requests registration of the target condition. The server registers information indicating a registrant of the target condition, in association with the digital asset, with the NFT.
(3) The NFT includes a digital image for visually confirming the NFT. The data management system further includes a third computer apparatus that requests registration of the digital image. The server registers information indicating a designer of the digital image, in association with the digital asset, with the NFT.
(4) The data management system further includes a fourth computer apparatus that transacts the NFT. The server transacts the NFT when agreement of a transaction of the NFTs is reached between the driver and a transactor, or between the transactor and another transactor.
(5) The data management system further includes another server. The other server includes a distributed ledger in which the NFT is stored, and functions as a node in a blockchain network.
(6) A data management method in accordance with a second aspect of the present disclosure includes: storing, in a distributed ledger, transaction data including an NFT which is a digital asset; registering a target condition in association with the NFT, the target condition being a condition concerning at least one of environment and safety that are desired to be achieved during driving; obtaining data for determining whether a vehicle has achieved the target condition; and giving, when the vehicle has achieved the target condition, the NFT associated with the achieved target condition to a driver of the vehicle.
(7) The registering includes: registering the target condition, when the target condition satisfies laws and international standards; and modifying, when the target condition does not satisfy the laws and the international standards, the target condition to satisfy the laws and the international standards and registering the modified target condition.
(8) The target condition includes at least one of a condition that fuel consumption or electricity consumption is better than a specified value, a condition that an amount of power consumption of air conditioning is smaller than a predetermined amount, a condition that an amount of emission of greenhouse gas is smaller than a criterion amount, a condition that a break time is longer than a first time, and a condition that a continuous driving time is shorter than a second time.
(9) A server in accordance with a third aspect of the present disclosure includes a processor that performs the data management method descried above.

In the configuration described above in (1) to (5), a digital asset is given as an NFT to a driver (the first computer apparatus) of the vehicle who has achieved a target condition. The target condition is set concerning at least one of environment and safety that are desired to be achieved during driving. Thereby, motivation to achieve the target condition and acquire the NFT is provided to the driver. Hence, according to the configuration described above in (1) to (5), driving in consideration of at least one of environment and safety can be promoted. Further, according to the method described above in (6) to (8) and the configuration described above in (9), driving in consideration of environment or safety can be promoted, as in the configuration described above in (1) to (5).

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a view showing an example of an overall configuration of a blockchain ecosystem in accordance with an embodiment of the present disclosure.

FIG. 2 is a view showing another example of the overall configuration of the blockchain ecosystem in accordance with the embodiment of the present disclosure.

FIG. 3 is a block diagram showing a typical configuration example of a marketplace.

FIG. 4 is a conceptual diagram of an NFT badge in the present embodiment.

FIG. 5 is a view for illustrating a target condition for acquiring an NFT badge.

FIG. 6 is a view for illustrating an outline of processing related to an NFT badge in the present embodiment.

FIG. 7 is a sequence diagram showing a series of processing procedures concerning registration of an NFT badge.

FIG. 8 is a flowchart showing an example of a processing procedure concerning identification of a target condition.

FIG. 9 is a sequence diagram showing a series of processing procedures concerning giving of an NFT badge.

FIG. 10 is a sequence diagram showing a series of processing procedures concerning a transaction of an NFT badge.

### DESCRIPTION OF THE PREFERRED EMBODIMENTS

Hereinafter, an embodiment of the present disclosure will be described in detail with reference to the drawings. It should be noted that identical or corresponding parts in the drawings will be designated by the same reference numerals, and the description thereof will not be repeated.

### EMBODIMENT

### <System Configuration>

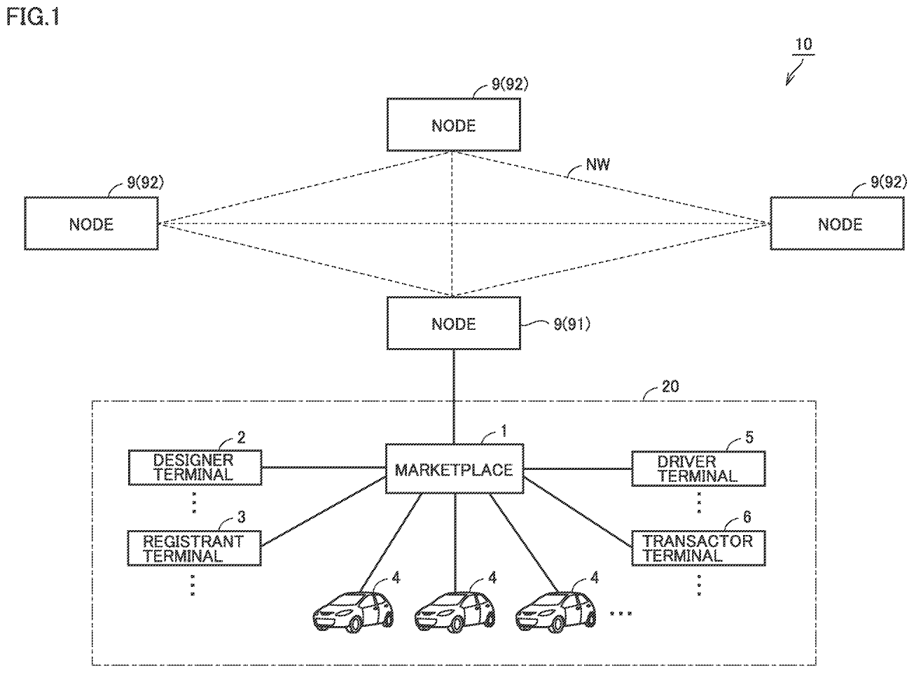

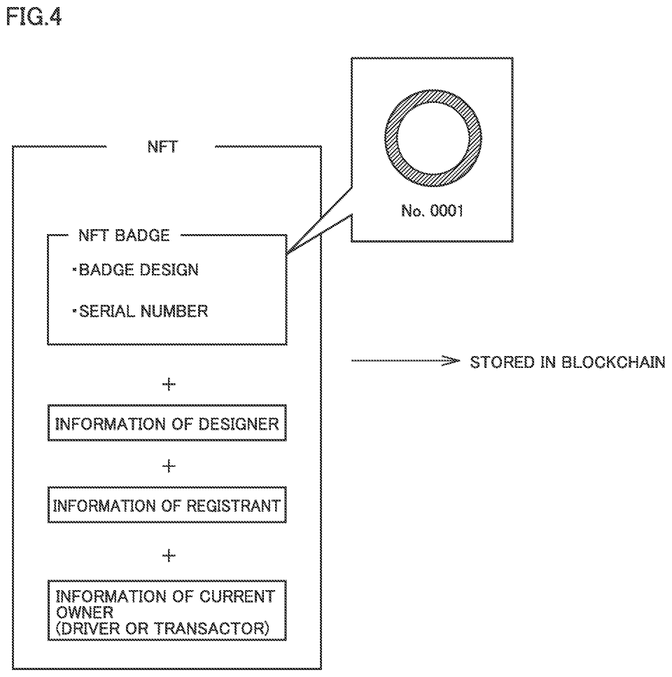

FIG. 1 is a view showing an example of an overall configuration of a blockchain ecosystem in accordance with an embodiment of the present disclosure. A blockchain ecosystem 10 manages data using a blockchain technique. The data managed by blockchain ecosystem 10 in the present embodiment is a non-fungible token (NFT) given to a manner of driving a vehicle. More specifically, when a “target condition” (which will be described later in detail) registered beforehand concerning driving in consideration of environment and/or safety has been achieved, a certificate formed as an NFT is given to a driver. Since this certificate has a badge-type design, the certificate formed as an NFT will be hereinafter referred to as an “NFT badge”. The NFT badge will be described in detail in and after FIG. 4.

Blockchain ecosystem 10 includes a plurality of nodes 9 and a data management system 20.

Each of the plurality of nodes 9 is a computer apparatus such as a server. Software for a blockchain infrastructure is installed in each node 9. The plurality of nodes 9 each having a function as a node of a blockchain communicate with one another via a network NW, thereby forming a distributed ledger network (blockchain network). The distributed ledger network may be of a public type, of a consortium type, or of a private type.

Data management system 20 includes, for example, a marketplace 1, a plurality of designer terminals 2, a plurality of registrant terminals 3, a plurality of vehicles 4, a plurality of driver terminals 5, and a plurality of transactor terminals 6. The number of each component included in data management system 20 is not particularly limited. In order to avoid complexity, a description will be given below based on an assumption that data management system 20 includes each component one by one.

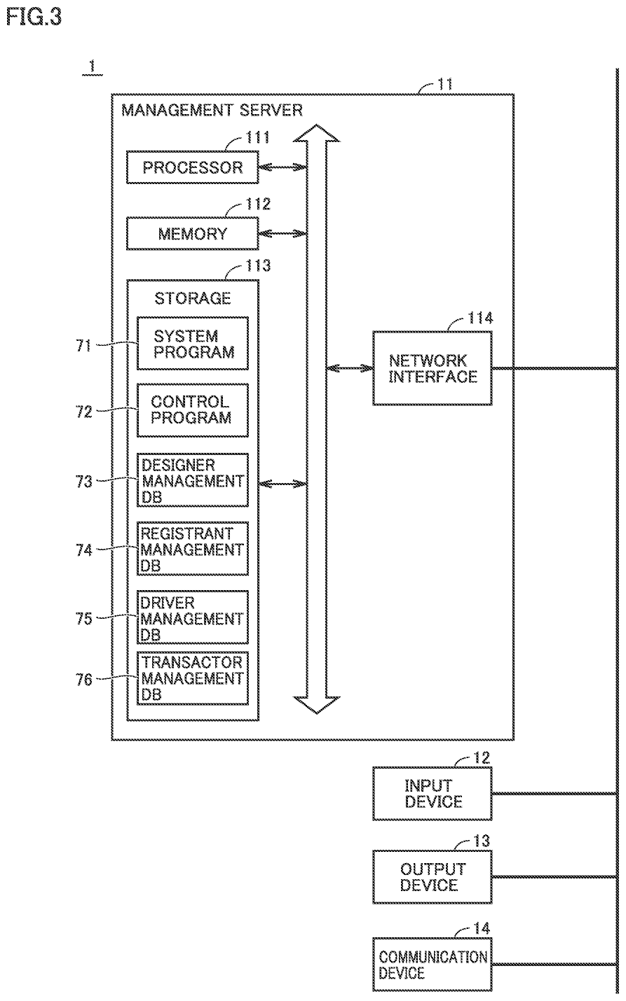

Marketplace 1 is organized, for example, by an organization (a company, an association, a consortium, or the like) that manages NFT badges. Marketplace 1 typically includes a server (see FIG. 3). Marketplace 1 is communicatively connected to designer terminal 2, registrant terminal 3, vehicle 4, driver terminal 5, and transactor terminal 6 via wired or wireless communication. Marketplace 1 manages (allocates) a cost and a reward incurred in connection with a variety of processing (such as registration, issuance, and exchange) related to an NFT badge.

Marketplace 1 obtains driving information of vehicle 4 from driver terminal 5, for example. The manner of obtaining the driving information of vehicle 4 is not limited. Marketplace 1 may obtain the driving information of vehicle 4 directly from vehicle 4, or may obtain the driving information of vehicle 4 from a data center that collects driving information of various vehicles (typically, a server organized by a vehicle manufacturer).

Marketplace 1 is communicatively connected to at least one of the plurality of nodes 9. Of the plurality of nodes 9, a node connected to marketplace 1 is denoted as a node 91, and nodes that are not directly connected to marketplace 1 are denoted as nodes 92. Marketplace 1 requests node 91 to issue an NFT badge, or requests node 91 to change the owner of an NFT badge (for example, to exchange an NFT badge).

Designer terminal 2, registrant terminal 3, driver terminal 5, and transactor terminal 6 are typically a smart phone, a tablet, a personal computer, a workstation, and the like. However, instead of such a client terminal, a server may be adopted.

Designer terminal 2 registers a design of an NFT badge by a designer (a digital image for visually confirming an NFT). Registrant terminal 3 registers a target condition for a driver to acquire an NFT badge. Target conditions may be registered by various registrants (in other words, may be publicly solicited). Vehicle 4 is driven by the driver. An NFT badge is given according to the driver's manner of driving vehicle 4. Driver terminal 5 displays an NFT badge, and accepts the driver's manipulation concerning issuance, a transaction, and the like of an NFT badge. Transactor terminal 6 displays an NFT badge, and accepts a transactor's manipulation concerning a transaction of an NFT badge between the driver and the transactor (or between transactors).

It should be noted that marketplace 1 corresponds to a “server” in accordance with the present disclosure. Driver terminal 5 corresponds to a “first computer apparatus” in accordance with the present disclosure. Registrant terminal 3 corresponds to a “second computer apparatus” in accordance with the present disclosure. Designer terminal 2 corresponds to a “third computer apparatus” in accordance with the present disclosure. Transactor terminal 6 corresponds to a “fourth computer apparatus” in accordance with the present disclosure. Node 9 (node 91) corresponds to “another server” in accordance with the present disclosure. The data center corresponds to an “external server” in accordance with the present disclosure.

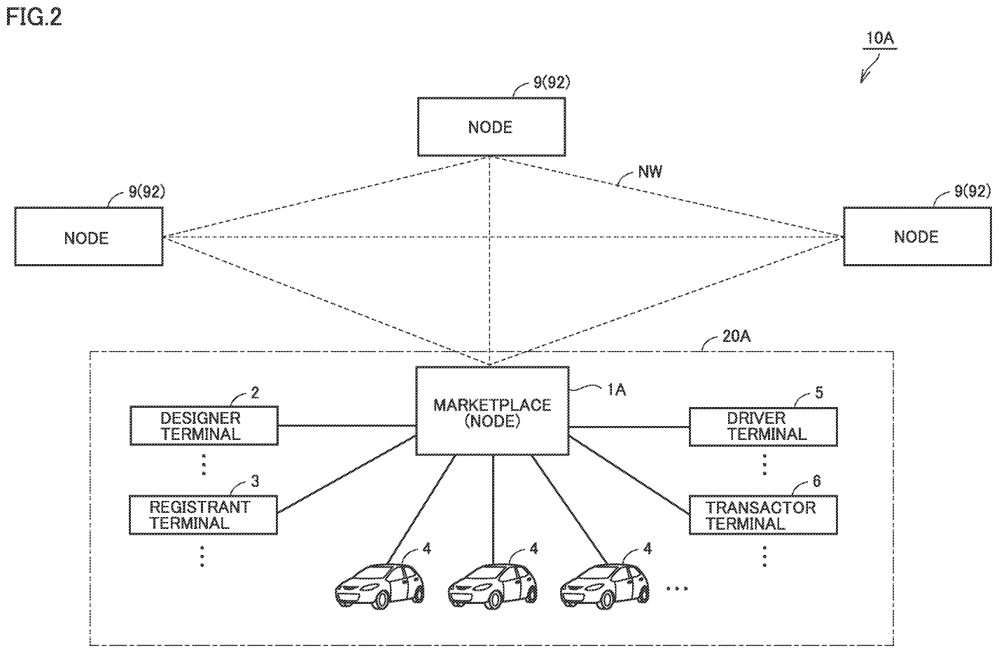

FIG. 2 is a view showing another example of the overall configuration of the blockchain ecosystem in accordance with the embodiment of the present disclosure. A blockchain ecosystem 10A shown in FIG. 2 includes a data management system 20A. Data management system 20A is different from data management system 20 shown in FIG. 1 in that a marketplace 1A has a function as a node of a blockchain. Due to the node function, marketplace 1A can issue an NFT badge by itself or change the owner of an NFT badge.

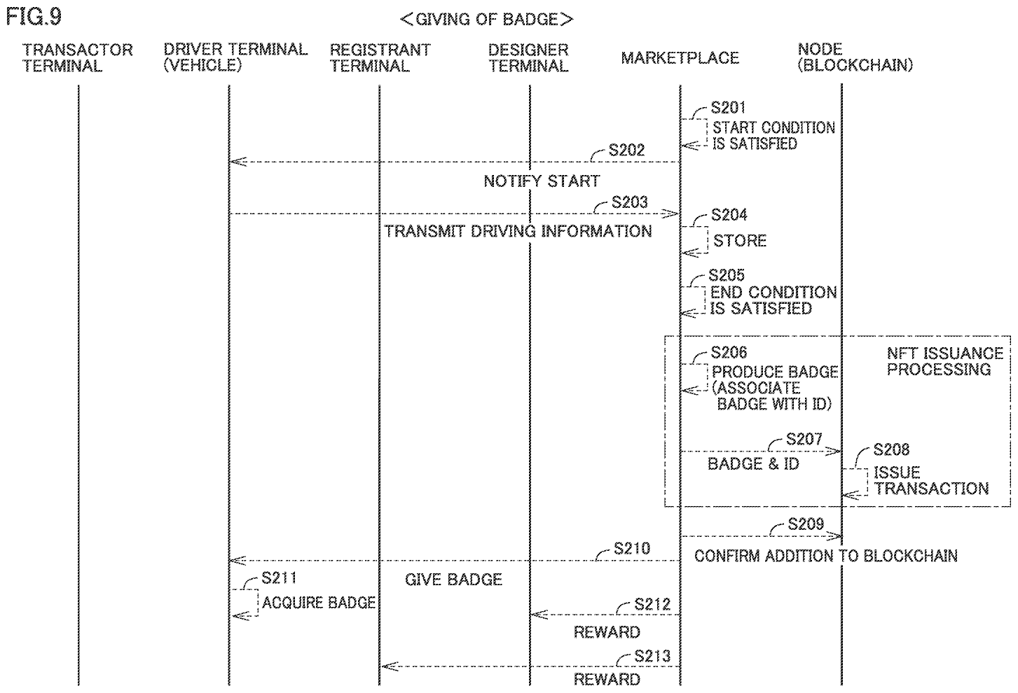

It should be noted that, in the present disclosure, “issuing an NFT” includes not only a case where marketplace 1A issues an NFT by itself as in the system configuration shown in FIG. 2, but also a case where marketplace 1 requests external node 91 to issue an NFT badge as in the system configuration shown in FIG. 1 (see FIG. 9). The same applies to other processing concerning an NFT badge (such as changing of the owner). Although the system configuration in FIG. 1 will be described below as an example, a person skilled in the art would be able to appropriately read it as the system configuration in FIG. 2.

FIG. 3 is a block diagram showing a typical configuration example of marketplace 1. Marketplace 1 includes a management server 11, an input device 12, an output device 13, and a communication device 14. Management server 11 includes a processor 111, a memory 112, a storage 113, and a network interface 114. The components of management server 11 are connected with one another by a communication bus.

Processor 111 is an arithmetic device such as a central processing unit (CPU) or a micro-processing unit (MPU). Memory 112 is a volatile memory (working memory) such as a random access memory (RAM). Storage 113 is a rewritable nonvolatile memory such as a hard disk drive (HDD), a solid state drive (SSD), or a flash memory.

Storage 113 stores a system program 71 including an operating system (OS), and a control program 72 including a computer readable code required for control operation. Processor 111 implements a variety of processing by reading system program 71 and control program 72, loading them in memory 112, and executing them. Storage 113 further stores a designer management database 73, a registrant management database 74, a driver management database 75, and a transactor management database 76.

Designer management database 73 includes, for example, a designer ID, a designer's basic information (name, address, mail address, and the like), registration history of a design of an NFT badge (a design registered in the past), and account information used to exchange a cost and/or a reward. Registrant management database 74 includes, for example, a registrant ID, a registrant's basic information, registration history of a target condition for acquiring an NFT badge, and account information. Driver management database 75 includes, for example, a driver ID, a driver's basic information, possession information (possession history) of an NFT badge, and account information. Transactor management database 76 includes, for example, a transactor ID, a transactor's basic information, possession information of an NFT badge, and account information. It should be noted that driver management database 75 and transactor management database 76 may be integrated into one database. Processor 111 registers, updates, and deletes records in these databases.

Network interface 114 is connected to input device 12, output device 13, and communication device 14. Input device 12 is a keyboard, a mouse, or the like, and accepts an input of an operator of management server 11. Output device 13 is a display, for example, and displays a variety of information for the operator of management server 11. Communication device 14 performs data communication with apparatuses external to marketplace 1 (such as designer terminal 2, registrant terminal 3, and node 91).

It should be noted that, although FIG. 3 shows an example where management server 11 includes one processor 111, management server 11 may include a plurality of processors. That is, management server 11 includes one or more processors. The same applies to memory 112 and storage 113. In the present specification, the “processor” is not limited to a narrowly defined processor that performs processing by a stored program method, and may also include a hard-wired circuit such as an application specific integrated circuit (ASIC) or a field-programmable gate array (FPGA). Accordingly, the term “processor” can also be read as processing circuitry in which processing is predefined by a computer readable code and/or a hard-wired circuit.

### <NFT Badge>

FIG. 4 is a conceptual diagram of an NFT badge in the present embodiment. The NFT badge includes a badge design and a serial number, for example. The NFT badge is stored in a distributed ledger (a blockchain in this example), together with information indicating a designer of the badge design of the NFT badge, information indicating a registrant of a target condition for acquiring the NFT badge, and information indicating a current owner (a driver or a transactor) of the NFT badge.

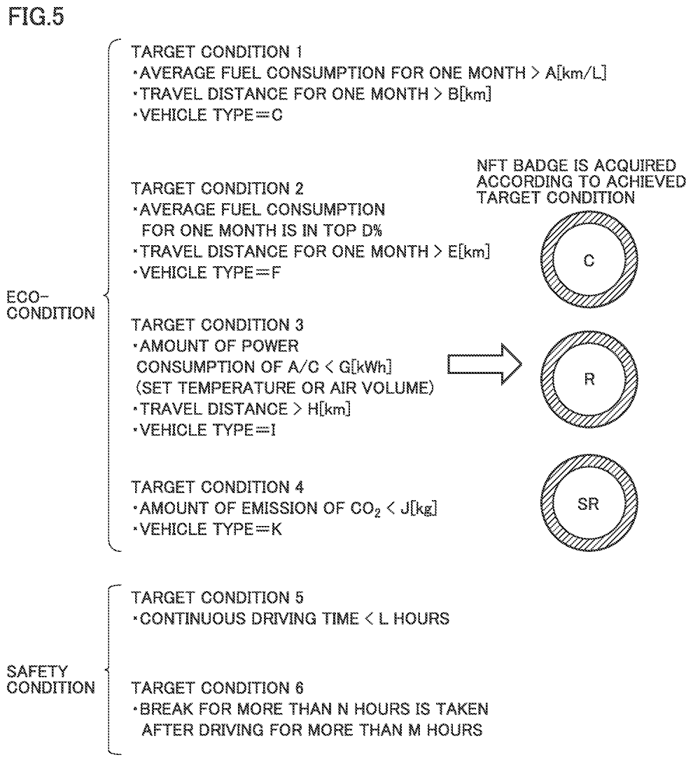

FIG. 5 is a view for illustrating a target condition for acquiring an NFT badge. The target condition includes at least one of an eco-condition and a safety condition. The eco-condition is a condition for determining whether driving in consideration of environment has been performed. The safety condition is a condition for determining whether safe driving has been performed (whether a driver has been in a state where the driver can perform safe driving).

FIG. 5 illustrates six exemplary target conditions 1 to 6. Target conditions 1 to 4 are eco-conditions, and target conditions 5 and 6 are safety conditions. While a description is given here of an example where the period for aggregating a parameter for each target condition is one month, the aggregation period may be set to any period.

Target conditions 1 and 2 are conditions concerning fuel consumption (which may be electricity consumption). As an example, when the average fuel consumption for one month is better than a predetermined value A [km/L], and the travel distance for one month is longer than a predetermined distance B [km], and the vehicle type is a specific vehicle type C, marketplace 1 determines that target condition 1 has been achieved. Although the fuel consumption may be expressed by an absolute value (A [km/L]) as in target condition 1, it may also be expressed, for example, by a relative value in the same vehicle type (in the top D %) as in target condition 2.

Target condition 3 is a condition concerning setting of an air-conditioner (A/C) mounted in a vehicle. Target condition 3 is achieved for example when the amount of power consumption of the air-conditioner for one month is less than a predetermined amount G [kWh], and the travel distance for one month is longer than a predetermined distance H [km], and the vehicle type is a specific vehicle type I. Instead of or in addition to the amount of power consumption of the air-conditioner, target condition 3 may include a condition concerning another parameter that influences the amount of power consumption, such as a set temperature of the air-conditioner, or a set air volume of the air-conditioner.

Target condition 4 is a condition concerning the amount of emission of greenhouse gas from a vehicle. Target condition 4 is achieved for example when the amount of emission of CO₂ for one month is less than a predetermined amount J [kg] and the vehicle type is a specific vehicle type K. It should be noted that the amount of emission of greenhouse gas such as CO₂ can be calculated from the amount of activity (the amount of fuel consumption and/or the amount of power consumption) of the vehicle, and a known emission factor (the amount of emission per the amount of activity). Instead of or in addition to the amount of emission of greenhouse gas, target condition 4 may include a condition concerning the amount of emission of an air pollution substance such as nitrogen oxide (NOx) or particulate matter (PM).

Target condition 5 is a condition concerning a continuous driving time of a vehicle. Target condition 5 is achieved for example when the continuous driving time in one month is less than predetermined L hours. Target condition 6 is a condition concerning a break time taken between two driving occasions (trips). Target condition 6 is achieved for example when a break for at least N hours is taken after driving for more than M hours in one month.

When a driver has achieved a target condition, marketplace 1 gives an NFT badge associated with the target condition to the driver, according to the target condition achieved by the driver. For example, one NFT badge may be associated with each of target conditions 1 to 6. One NFT badge may be associated with a combination of two or more conditions of target conditions 1 to 6.

The NFT badge may be ranked according to the level of difficulty in achieving a target condition. As an example, when a target condition that is relatively easy to achieve has been achieved, marketplace 1 gives a common NFT badge (common badge) to a driver. When a target condition that is relatively difficult to achieve has been achieved, marketplace 1 gives a rare NFT badge (rare badge) to a driver. When a target condition that is very difficult to achieve has been achieved, marketplace 1 gives a very rare NFT badge (super rare badge) to a driver.

### <Outline of Processing>

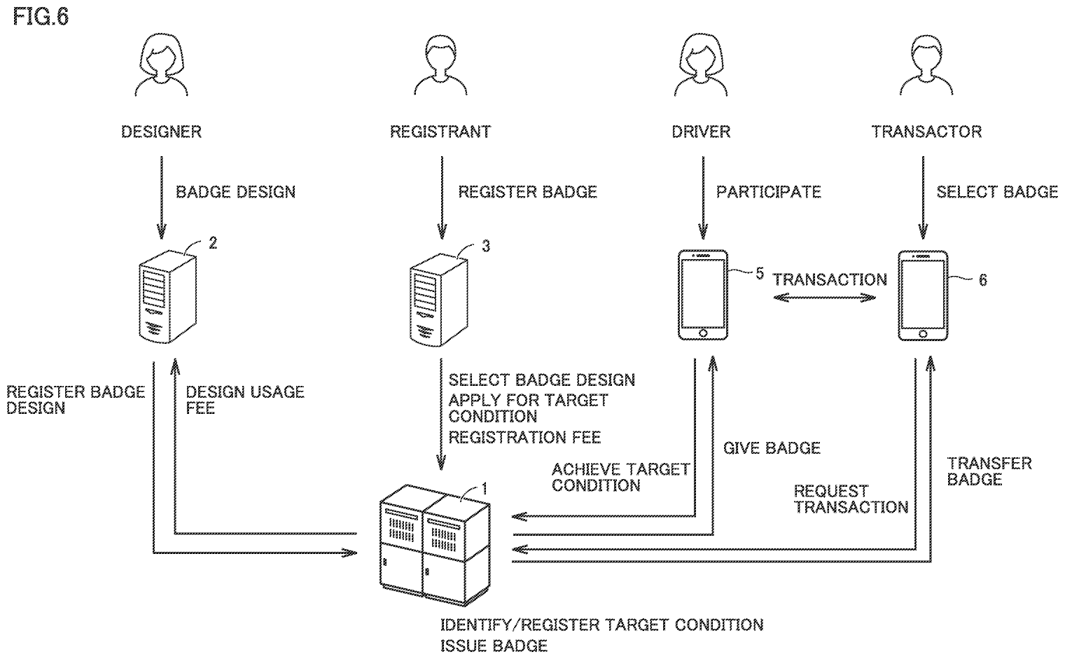

FIG. 6 is a view for illustrating an outline of processing related to an NFT badge in the present embodiment. An app (software) for registering a badge design of an NFT badge is installed in designer terminal 2. When a designer produces a badge design, the designer causes the badge design to be read into the app. Designer terminal 2 applies for registration of the read badge design with marketplace 1 (requests marketplace 1 to register the read badge design).

An app (software) for registering an NFT badge is installed in registrant terminal 3. A registrant who attempts to register an NFT badge selects a desired badge design, on the app, from various badge designs registered with marketplace 1. Further, the registrant inputs a target condition for acquiring the NFT badge. According to manipulation by the registrant, registrant terminal 3 notifies marketplace 1 of the selected badge design, and applies for registration of the inputted target condition with marketplace 1 (requests marketplace 1 to register the inputted target condition).

The target condition applied from registrant terminal 3 is not necessarily appropriate from the viewpoint of environment and safety. There is a possibility where the target condition is illegal (does not conform to regulations). There is also a possibility where the target condition is excessively easy or difficult to achieve and thus is substantially meaningless. Accordingly, it is preferable that marketplace 1 identifies whether the target condition applied from registrant terminal 3 is appropriate. Marketplace 1 may identify only the target condition that satisfies a predetermined criterion as appropriate, and may register it. Alternatively, marketplace 1 may modify a portion of the target condition applied from registrant terminal 3 to satisfy the predetermined criterion, and may register the modified target condition.

Registrant terminal 3 may pay the cost of registering an NFT badge to marketplace 1. As illustrated in FIG. 4, an NFT badge is associated with a registrant name (usually a company name) of the NFT badge. Accordingly, it is considered that the registrant is willing to pay the cost as a cost of advertising the registrant name (a sponsorship cost for the NFT badge). An organizer of marketplace 1 receives a portion of the cost paid from registrant terminal 3 to marketplace 1, as a registration fee. Another portion of the cost paid from registrant terminal 3 to marketplace 1 may be paid to designer terminal 2 via management server 11, which will be described later in detail. Thereby, the designer of the badge design selected by the registrant can receive a reward (design usage fee).

However, registrant terminal 3 does not always pay the cost, and registrant terminal 3 may receive a reward. For example, when participating in an activity for acquiring an NFT badge, a driver may pay a cost (participation fee), and registrant terminal 3 may receive a portion thereof.

It should be noted that, in this example, it is assumed that the cost and the reward are exchanged using a virtual currency (crypto currency). However, the currency used to exchange the cost and the reward is not limited to a virtual currency, and may be a real currency (cash, account balance). Instead of currency, points in a point service may be used.

An app for acquiring an NFT badge is installed in driver terminal 5. A driver selects an NFT badge that the driver tries to acquire, on the app, from various NFT badges and target conditions registered with marketplace 1. Driver terminal 5 notifies marketplace 1 of the selected NFT badge (participates in the activity).

An app for obtaining driving information of a vehicle may further be installed in driver terminal 5. Driver terminal 5 periodically obtains a parameter related to the target condition of the selected NFT badge (such as fuel consumption, travel distance, the amount of emission of greenhouse gas, or continuous driving time), from the data center that collects various vehicle information, for example. Then, driver terminal 5 transmits the obtained parameter to marketplace 1.

Marketplace 1 determines whether the target condition has been achieved, based on the parameter obtained from driver terminal 5. When the target condition has been achieved, marketplace 1 gives the NFT badge to driver terminal 5.

An app for transacting an NFT badge is installed in transactor terminal 6. A transaction of an NFT badge may be a transaction between an NFT badge and a virtual currency, or may be exchange of NFT badges. Transactor terminal 6 displays NFT badges owned and collected by various drivers and various transactors. A transactor selects, on the app, an NFT badge for which a transaction between the driver and the transactor (or between one transactor and another transactor) is desired. When both of the driver and the transactor have agreed to the transaction, transactor terminal 6 requests marketplace 1 to transact the selected NFT badge. Marketplace 1 notifies transactor terminal 6 of completion of the transaction (completion of exchange of NFT badges).

### <Processing Procedure>

### <<Registration of NFT Badge>>

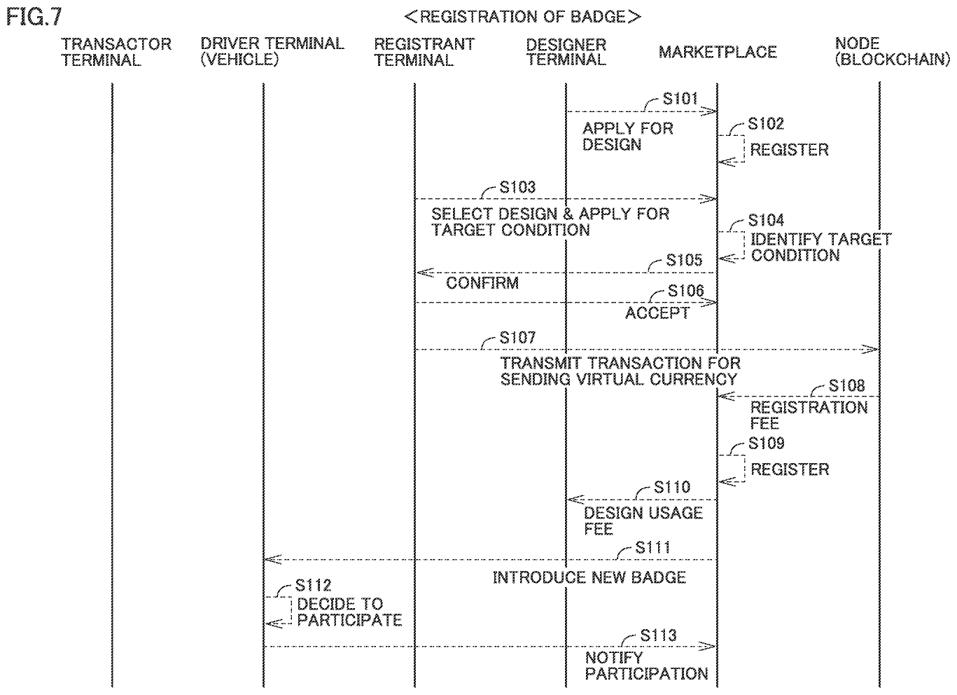

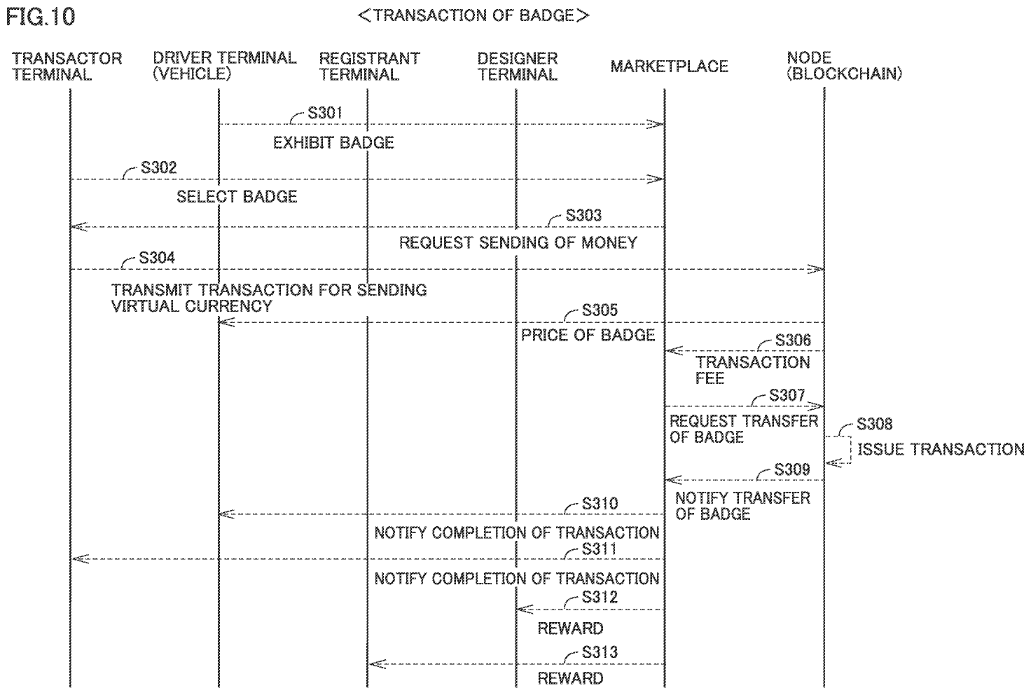

FIG. 7 is a sequence diagram showing a series of processing procedures concerning registration of an NFT badge. FIG. 7 shows, in order from the left to the right, processing performed by transactor terminal 6, driver terminal 5 (which may partially be vehicle 4), registrant terminal 3, designer terminal 2, marketplace 1, and node 91 (blockchain). The same applies to FIGS. 9 and 10 described later. In the following, a step is abbreviated as S.

In S101, designer terminal 2 requests marketplace 1 to register a badge design produced by a designer (applies for registration). Marketplace 1 registers the badge design according to the request from designer terminal 2 (S102). On this occasion, an examination of whether the badge design is appropriate in view of copyright, public policy, and the like may be performed.

In S103, registrant terminal 3 selects a badge design according to manipulation by a registrant. Further, registrant terminal 3 requests marketplace 1 to register a target condition according to manipulation by the registrant (applies for registration). Marketplace 1 identifies whether the target condition requested from registrant terminal 3 to be registered is appropriate or not (S104).

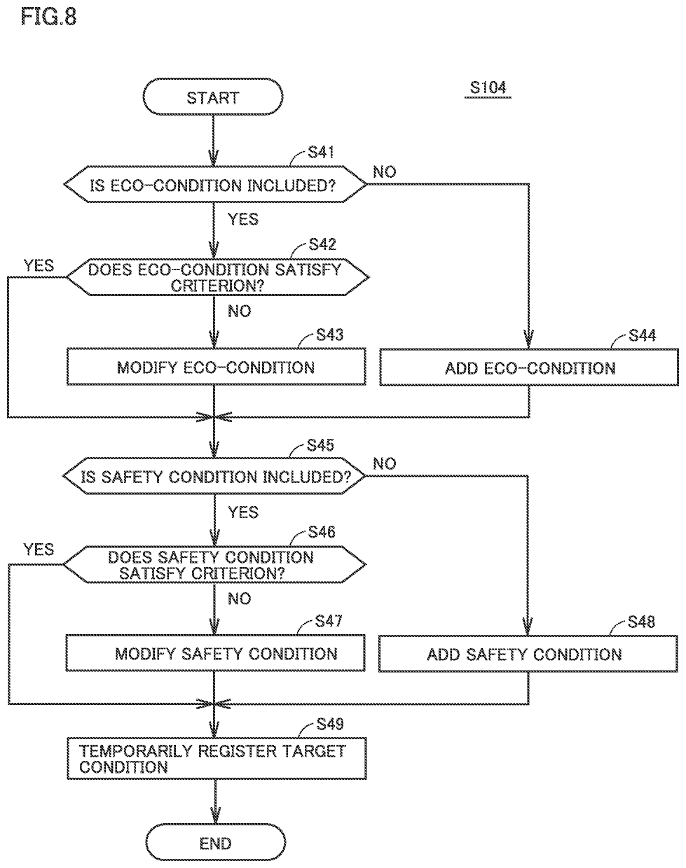

FIG. 8 is a flowchart showing an example of a processing procedure concerning identification of a target condition (processing procedure in S104). The processing shown in this flowchart is performed by marketplace 1 for example when registration of a target condition is requested from registrant terminal 3 (when a target condition is inputted by the registrant).

In S41, marketplace 1 determines whether the target condition inputted by the registrant includes an eco-condition. When the target condition includes an eco-condition (YES in S41), marketplace 1 determines whether the eco-condition included in the target condition satisfies a predetermined criterion (S42). The criterion is determined to satisfy at least laws (including government ordinances, ministerial ordinances, notifications, and the like) and international standards, and is preferably determined to an appropriate value also from the viewpoint of social responsibility. When the eco-condition included in the target condition satisfies the criterion (YES in S42), marketplace 1 advances the processing to S45. When the eco-condition included in the target condition does not satisfy the criterion (NO in S42), marketplace 1 modifies the eco-condition (S43) to satisfy the criterion, and advances the processing to S45. It should be noted that, when the target condition does not include an eco-condition in S41 (NO in S41), marketplace 1 adds an eco-condition that satisfies the criterion (S44), and then advances the processing to S45.

In S45, marketplace 1 determines whether the target condition inputted by the registrant includes a safety condition. When the target condition includes a safety condition (YES in S45), marketplace 1 determines whether the safety condition included in the target condition satisfies a predetermined criterion (S46). This criterion is also predetermined from the viewpoint of laws, international standards, social responsibility, and the like, as with the criterion concerning the eco-condition. When the safety condition included in the target condition satisfies the criterion (YES in S46), marketplace 1 advances the processing to S49. When the safety condition included in the target condition does not satisfy the criterion (NO in S46), marketplace 1 modifies the safety condition (S47) to satisfy the criterion, and advances the processing to S49. It should be noted that, when the target condition does not include a safety condition in S45 (NO in S45), marketplace 1 adds a safety condition that satisfies the criterion (S48), and then advances the processing to S49.

In S49, marketplace 1 temporarily registers the target condition that satisfies the eco-condition and the safety condition.

Referring back to FIG. 7, in S105, marketplace 1 transmits the temporarily registered target condition to registrant terminal 3, and checks with the registrant to confirm whether the temporarily registered target condition has no problem (whether it is acceptable). When the registrant accepts it, registrant terminal 3 notifies marketplace 1 accordingly (S106). Further, registrant terminal 3 transmits, to node 91, transaction data for sending a virtual currency, according to manipulation by the registrant (S107). Node 91 sends a registration fee to marketplace 1 (S108). When marketplace 1 receives a notice of acceptance from registrant terminal 3 and receives payment of the registration fee, marketplace 1 registers the target condition that has been in a temporarily registered state (S109). Thereby, an NFT badge (a combination of the badge design and the target condition) is registered.

As described above, when the NFT badge is registered, a portion of the registration fee may be returned to the designer who produced badge data adopted in the NFT badge. In S110, marketplace 1 sends a portion of the registration fee as a design usage fee to designer terminal 2.

In S111, marketplace 1 notifies driver terminal 5 of the newly registered NFT badge. Driver terminal 5 displays the newly registered NFT badge and introduces it to a driver (user). When the driver confirms the NFT badge on the app and decides to participate in an activity for acquiring the NFT badge (S112), participation is notified from driver terminal 5 to marketplace 1 (S113). Although not shown, a fee for participating in the activity may be paid from driver terminal 5 to marketplace 1.

It should be noted that FIG. 8 illustrates that the target condition includes both an eco-condition and a safety condition. From the viewpoint of environment and safety, it is desirable that the target condition includes both conditions. However, as illustrated in FIG. 5, the target condition may include only one of an eco-condition and a safety condition.

### <<Giving of NFT Badge>>

FIG. 9 is a sequence diagram showing a series of processing procedures concerning giving of an NFT badge. In S201, marketplace 1 determines whether a start condition for an activity for acquiring an NFT badge is satisfied (for example, whether a start time for a period determined in a target condition has been reached). When the start condition is satisfied, marketplace 1 notifies driver terminal 5 of the start of the activity (S202). Marketplace 1 may notify vehicle 4 of the start of the activity, in addition to driver terminal 5.

In S203, driver terminal 5 transmits driving information of vehicle 4 to marketplace 1. As described above, the app in driver terminal 5 periodically obtains the driving information of vehicle 4 from the data center that collects driving information of vehicles 4. Driver terminal 5 may transmit a parameter related to the target condition (such as fuel consumption, travel distance, the amount of emission of greenhouse gas, or continuous driving time) to marketplace 1, after a lapse of a period determined in the target condition (for example, one month). Driver terminal 5 may transmit the parameter related to the target condition to marketplace 1, periodically at a shorter time interval (for example, once every day). Alternatively, the parameter related to the target condition may be transmitted from vehicle 4 to marketplace 1.

Marketplace 1 stores the driving information (the parameter related to the target condition) obtained from driver terminal 5 (or vehicle 4) in driver management database 75 (see FIG. 3) (S204). Marketplace 1 determines whether a predetermined end condition is satisfied (for example, whether an end time for the period determined in the target condition has been reached) (S205). Here, a situation is assumed where the target condition has been achieved when the end condition is satisfied.

In S206 to S208, marketplace 1 performs NFT issuance processing together with node 91. More specifically, first, marketplace 1 produces an NFT badge, and associates the NFT badge with a driver ID (S206). Marketplace 1 transmits the NFT badge and the driver ID associated with each other to node 91 (S207). Node 91 issues a transaction based on data from marketplace 1 (S208). That is, node 91 produces transaction data, adds an electronic signature to the produced transaction data, and transmits it to another node 92 in blockchain ecosystem 10. The transaction data transmitted to other node 92 is added to a distributed ledger (blockchain) of other node 92 based on a known agreement formation algorithm.

In S209, marketplace 1 confirms addition of the transaction data to the distributed ledger. When the addition of the transaction data is confirmed, marketplace 1 gives the NFT badge to driver terminal 5 (S210). As a result, driver terminal 5 acquires the NFT badge (S211).

In this example, when the NFT badge is given, a portion of the cost (registration fee and/or participation fee) is returned to the designer of the badge design of the NFT badge and the registrant of the target condition. Marketplace 1 transmits a portion of the cost to designer terminal 2 (S212). Further, marketplace 1 transmits a portion of the cost to registrant terminal 3 (S213).

### <<Transactions of NFT Badge>>

FIG. 10 is a sequence diagram showing a series of processing procedures concerning a transaction of an NFT badge. Here, a description is given of an example where an NFT badge is transferred from a driver to a transactor, and an NFT badge virtual currency is paid from the transactor to the driver.

In S301, driver terminal 5 exhibits an NFT badge in marketplace 1. That is, the NFT badge of the driver becomes available for purchase. In S302, transactor terminal 6 selects, in marketplace 1, an NFT badge that the transactor desires to purchase. Thereby, it can be said that a transaction of the NFT badge between driver terminal 5 and transactor terminal 6 is agreed.

In S303, marketplace 1 requests transactor terminal 6 to send a virtual currency. The amount of money to be sent is the sum of a price of the NFT badge and a transaction fee. Transactor terminal 6 transmits, to node 91, transaction data for sending the virtual currency, according to manipulation by the transactor (S304). Node 91 sends the price of the NFT badge to driver terminal 5 (S305). Further, node 91 sends the transaction fee to marketplace 1 (S306).

In S307, marketplace 1 requests node 91 to transfer the NFT badge from the driver to the transactor (i.e., to change the owner of the NFT badge). In response to the request from marketplace 1, node 91 issues a transaction for transferring the NFT badge (S308). Thereby, owner information of the NFT badge is changed from the driver to the transactor. After the transaction is completed, node 91 notifies marketplace 1 that the NFT badge has been transferred from the driver to the transactor (S309). Thereafter, node 91 notifies driver terminal 5 and transactor terminal 6 that the transaction (exchange between the NFT badge and the price) has been completed (S310, S311).

In this example, also when the NFT badge is transacted, a portion of the transaction fee is returned to the designer of the NFT badge and the registrant. Marketplace 1 transmits a portion of the transaction fee as a reward to designer terminal 2 (S312). Further, marketplace 1 transmits a portion of the transaction fee as a reward to registrant terminal 3 (S313).

FIG. 10 illustrates an example where an NFT badge and a virtual currency are exchanged. However, NFT badges may be exchanged. A person skilled in the art would readily understand a processing procedure concerning such a transaction, from FIG. 10.

As described above, in the present embodiment, an NFT badge is given when a driver has achieved a target condition. The target condition includes an eco-condition and a safety condition, and is determined to implement reduction in environmental load and safe driving from the viewpoint of laws, international standards, social responsibility, and the like. Therefore, when the target condition has been achieved based on motivation to acquire the NFT badge, environmental load is reduced and safe driving is ensured. Hence, according to the present embodiment, driving in consideration of environment and safety can be promoted.

Although the embodiment of the present disclosure has been described, it should be understood that the embodiment disclosed herein is illustrative and non-restrictive in every respect. The scope of the present disclosure is defined by the scope of the claims, and is intended to include any modifications within the scope and meaning equivalent to the scope of the claims.

What is claimed is:

1. A data management system comprising:
a server that manages a digital asset as a non-fungible token (NFT); and
a first computer apparatus used by a driver of a vehicle to acquire the NFT, wherein
the server registers each of a plurality of target conditions in association with the NFT, the plurality of target conditions being conditions concerning at least one of environment and safety that are desired to be achieved during driving,
the first computer apparatus notifies the server of a target condition selected by the driver from the plurality of target conditions,
the server obtains, from the vehicle, the first computer apparatus, or an external server, data for determining whether driving of the vehicle by the driver has achieved the selected target condition, and
when the driving of the vehicle by the driver has achieved the selected target condition, the server gives the NFT associated with the achieved target condition to the first computer apparatus.

2. The data management system according to claim 1, further comprising a second computer apparatus that requests registration of the target condition, wherein
the server registers information indicating a registrant of the target condition, in association with the digital asset, with the NFT.

3. The data management system according to claim 1, wherein
the NFT includes a digital image for visually confirming the NFT,
the data management system further comprises a third computer apparatus that requests registration of the digital image, and
the server registers information indicating a designer of the digital image, in association with the digital asset, with the NFT.

4. The data management system according to claim 1, further comprising a fourth computer apparatus that transacts the NFT, wherein
the server transacts the NFT when agreement of a transaction of the NFTs is reached between the driver and a transactor, or between the transactor and another transactor.

5. The data management system according to claim 1, further comprising another server, wherein
the other server includes a distributed ledger in which the NFT is stored, and functions as a node in a blockchain network.

6. A data management method comprising:
storing, in a distributed ledger, transaction data including an NFT which is a digital asset;
registering a target condition in association with the NFT, the target condition being a condition concerning at least one of environment and safety that are desired to be achieved during driving;
obtaining data for determining whether a vehicle has achieved the target condition; and
giving, when the vehicle has achieved the target condition, the NFT associated with the achieved target condition to a driver of the vehicle.

7. The data management method according to claim 6, wherein
the registering includes
registering the target condition, when the target condition satisfies laws and international standards, and
modifying, when the target condition does not satisfy the laws and the international standards, the target condition to satisfy the laws and the international standards and registering the modified target condition.

8. The data management method according to claim 6, wherein the target condition includes at least one of:
a condition that fuel consumption or electricity consumption is better than a specified value;
a condition that an amount of power consumption of air conditioning is smaller than a predetermined amount;
a condition that an amount of emission of greenhouse gas is smaller than a criterion amount;
a condition that a break time is longer than a first time; and
a condition that a continuous driving time is shorter than a second time.

9. A server comprising a processor that performs the data management method according to claim 6.
